(19) United States
(12) Patent Application Publication
(10) Pub. No.: US 2026/0015076 A1
(43) Pub. Date: Jan. 15, 2026

(54) BARRIER SYSTEM AND METHOD FOR A CARGO COMPARTMENT OF AN AIRCRAFT

(71) Applicant: THE BOEING COMPANY, Arlington, VA (US)

(72) Inventors: Nicholas Alexander Jones, Lynnwood, WA (US); Eric Legaspi Sarinas, Lynnwood, WA (US); Chay P. Weaver, Seattle, WA (US); Jacob Bevan McWhirter, Lake Stevens, WA (US)

(73) Assignee: THE BOEING COMPANY, Arlington, VA (US)

(21) Appl. No.: 18/772,447

(22) Filed: Jul. 15, 2024

(51) Int. Cl. B64C 1/10

(52) U.S. Cl. CPC B64C 1/10

(57) ABSTRACT

A barrier system is configured for a cargo compartment of an aircraft. The barrier system includes a base configured to be supported on a floor of the cargo compartment. A divider wall extends upwardly from the base. A closeout membrane extends around one or more portions of the divider wall. The closeout membrane is configured to sealingly engage one or more portions of the cargo compartment. The barrier system is configured to be moved within the cargo compartment to provide an isolation zone within the cargo compartment.

### FIELD OF THE DISCLOSURE

Examples of the present disclosure generally relate to barrier systems and methods, such as for a cargo compartment of an aircraft.

### BACKGROUND OF THE DISCLOSURE

Vehicles such as commercial aircraft are used to transport passengers and/or cargo between various locations. A typical aircraft includes an internal cabin having seats for passengers and a cargo compartment that may be below the passenger cabin. As another example, a freighter aircraft includes a main deck compartment. That is, a freighter aircraft can include an internal cabin dedicated to transporting cargo instead of passengers.

Typically, cargo within upper or lower decks of a freighter aircraft are not environmentally segregated along a length of the aircraft. That is, the cargo compartment is typically an open volume of space. As such, as a cargo door is opened, an entirety of the cargo volume is exposed to local ambient conditions, which can undesirably affect sensitive cargo (such as animals or plants).

### SUMMARY OF THE DISCLOSURE

A need exists for a system and a method for protecting certain types of cargo within a cargo compartment of a vehicle, such as a freighter aircraft. Further, a need exists for a system and a method for selectively segregating areas within a cargo compartment of a vehicle.

With those needs in mind, certain examples of the present disclosure provide a barrier system for a cargo compartment of an aircraft. The barrier system includes a base configured to be supported on a floor of the cargo compartment. A divider wall extends upwardly from the base. A closeout membrane extends around one or more portions of the divider wall. The closeout membrane is configured to sealingly engage one or more portions of the cargo compartment. The barrier system is configured to be moved within the cargo compartment to provide an isolation zone within the cargo compartment.

In at least one example, the cargo system is configured to linearly translate along a length of the cargo compartment.

The base can include one or more rollers configured to allow the barrier system to roll over the floor of the cargo compartment.

In at least one example, the base is coupled to a cargo handling system that is configured to move the barrier system within the cargo compartment.

In at least one example, the divider wall is rigid.

In at least one example, the divider wall includes one or more vents.

The barrier system can also include a door moveably coupled to the divider wall. The door is moveable between an open position and a closed position.

The closeout membrane can be inflatable.

The barrier system can include one or more support struts. The divider wall can be flexible and coupled to the one or more support struts. The divider wall can include one or more inflatable portions. The one or more support struts are moveable between an extended position and a collapsed position. The one or more support struts in the extended position support the divider wall in a deployed position, and the one or more support struts in the collapsed position support the divider wall in a stowed position.

The barrier system can also include a user interface in communication with an environmental control system.

Certain examples of the present disclosure provide a method including moving the barrier system within the cargo compartment to provide an isolation zone within the cargo compartment.

Certain examples of the present disclosure provide an aircraft including a cargo compartment, and a barrier system, as described herein.

### BRIEF DESCRIPTION OF THE DRAWINGS

FIG. 1 illustrates a perspective front view of an aircraft, according to an example of the present disclosure.

FIG. 2 illustrates an isometric internal view of a cargo compartment, according to an example of the present disclosure.

FIG. 3 illustrates an isometric front view of a barrier system, according to an example of the present disclosure.

FIG. 4 illustrates a front view of the barrier system of FIG. 3.

FIG. 5 illustrates an isometric front view of a barrier system in a deployed position, according to an example of the present disclosure.

FIG. 6 illustrates a front view of the barrier system of FIG. 5.

FIG. 7 illustrates an isometric top view of the barrier system of FIG. 5 in a stowed position, according to an example of the present disclosure.

FIG. 8 illustrates an internal perspective view of a cargo compartment, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide a mobile environmental barrier system configured for use within a cargo compartment, such as within a freighter aircraft. The barrier system provides one or more soft isolation zones within the cargo compartment. The isolation zones provide areas where temperature and humidity changes are reduced when on ground (and/or in air) when a main cargo door(s) is open. The barrier system and method described herein is configured to support sensitive cargo like live animals and plants that may be adversely affected by drastic environmental changes, such as substantial shifts in temperature and/or humidity. The barrier system and method are configured to control environmental conditions within a particular zone of a cargo compartment.

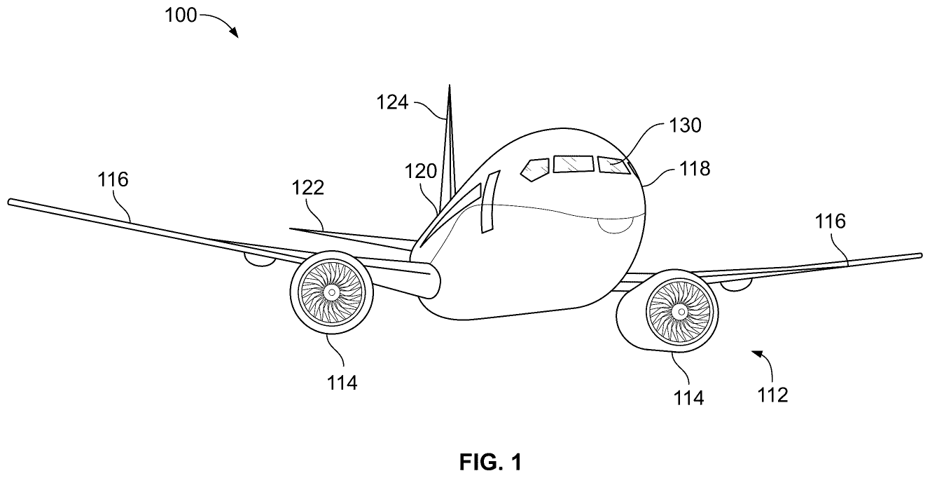

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130. The internal cabin 130 includes a cargo compartment. For example, the cargo compartment can be a main deck cargo compartment. The internal cabin 130 can also include a passenger seating area. Optionally, the internal cabin may not include a passenger seating area. As another example, the cargo compartment can be outside of the internal cabin (such as underneath a floor).

Alternatively, instead of an aircraft, examples of the present disclosure may be used with various other vehicles, such as buses, locomotives and train cars, watercraft, spacecraft, and the like.

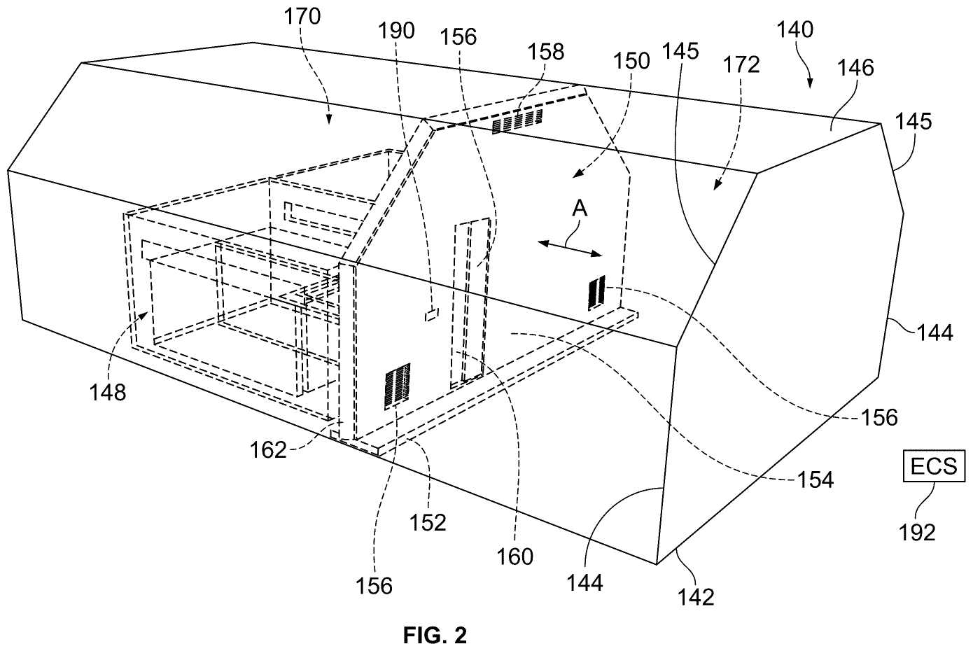

FIG. 2 illustrates an isometric internal view of a cargo compartment 140, according to an example of the present disclosure. The cargo compartment 140 is within an internal cabin of a vehicle, such as within the internal cabin 130 of the aircraft 100 shown in FIG. 1. The cargo compartment 140 can be a cargo liner within the internal cabin. The cargo compartment 140 includes a floor 142, outer walls 144, and a ceiling 146. In at least one example, the floor 142 includes a cargo handling system, which can include rollers, configured to allow cargo pallets, containers, and the like to be moved within the cargo compartment 140. Cargo 148 can be stored within the cargo compartment 140 As an example, the cargo 148 can include one or more stalls that retain livestock, such as horses.

In order to environmentally protect the cargo 148 from other areas of the cargo compartment 140, a barrier system 150 is disposed within the cargo compartment 140. The barrier system 150 is moveable within the cargo compartment 140. For example, the barrier system 150 is configured to linearly translate along a length of the cargo compartment 140 in the directions of arrows A. The barrier system 150 can be selectively moved to a desired position within the cargo compartment. In at least one example, the barrier system 150 can be moved by or otherwise over the cargo handling system to a desired position, and selectively locked in place.

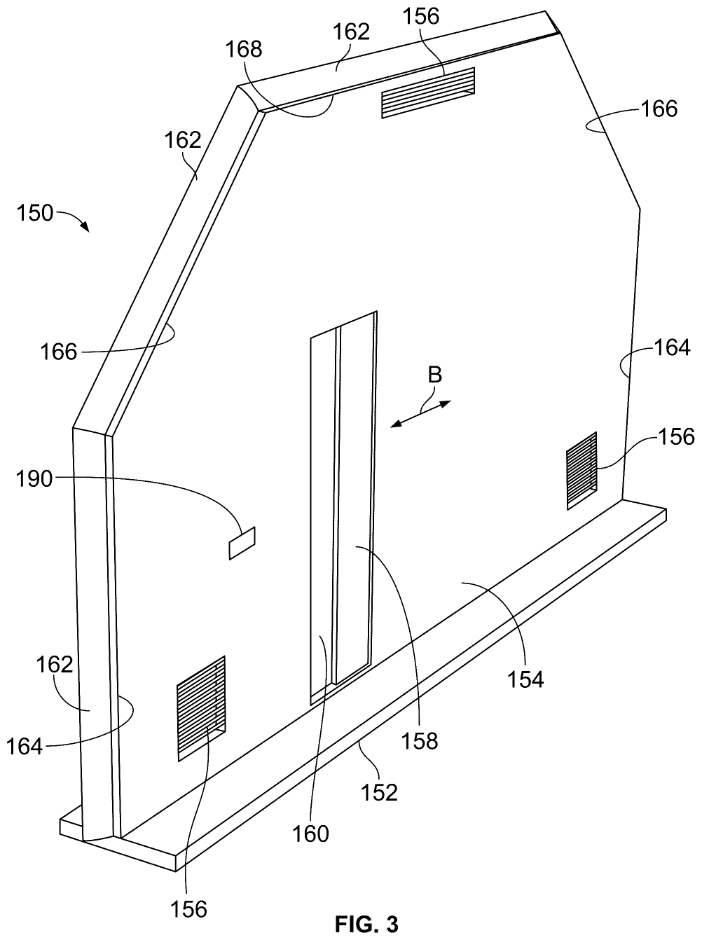

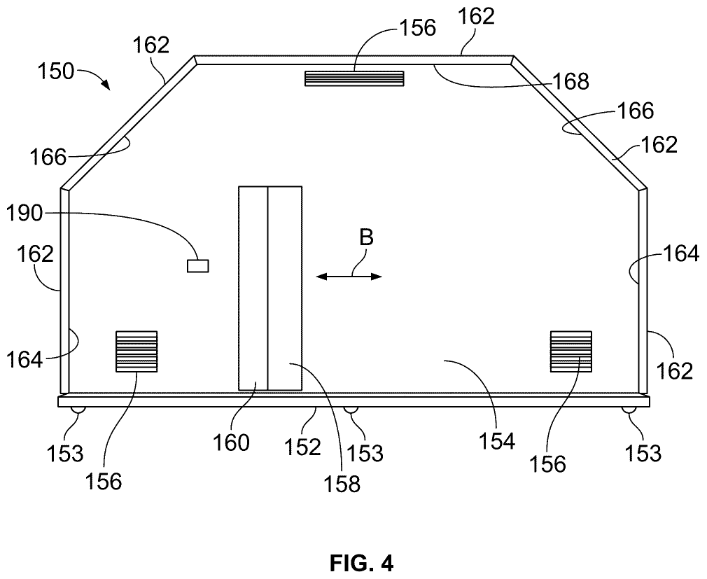

FIG. 3 illustrates an isometric front view of the barrier system 150, according to an example of the present disclosure. FIG. 4 illustrates a front view of the barrier system 150 of FIG. 3. Referring to FIGS. 2-4, the barrier system 150 includes a base 152 that is supported on the floor 142 of the cargo compartment 140. In at least one example, the base 152 can be a flat panel, which can be formed of metal. In at least one example, one or more rollers 153 (such as wheels) can extend from lower surfaces of the base 152. The rollers 153 allow for the barrier system 150 to roll over the floor 142 of the cargo compartment 140. Optionally, the base 152 may not include the rollers. Instead, the base 152 can be rollingly supported on rollers of a cargo handling system disposed on the floor 142.

A divider wall 154 extends upwardly from the base 152, and is sized and shaped to conform to an interior profile of the cargo compartment 140. The divider wall 154 can be sized and shaped differently, depending on the size and shape of the cargo compartment 140. In at least one example, the divider wall 154 is a rigid structure. The divider wall 154 can be formed of a composite material, which can include a honeycomb core laminated to one or more outer skins. As another example, the divider wall 154 can be formed of metal. As another example, the divider wall 154 can be formed of plastic. In at least one example, the divider wall 154 includes an insulated core.

As shown, vents 156 are disposed within the divider wall 154. For example, a vents 156 can be disposed at lower bottom corners of the divider wall 154, at a top portion of the divider wall 154, and/or the like. The divider wall 154 can include more or less vents 156 that shown. The vents 156 allow air to pass therethrough to control airflow through the divider wall 154. The vents 156 can include moveable louvers, slats, dampers, or the like, which can be selectively operated to control airflow.

A door 158 is moveably coupled to the divider wall 154. The door 158 is selectively moveable between a closed position, in which a threshold 160 extending through the divider wall 154 is closed, and an open position, in which the threshold 160 is opened. In at least one example, the door 158 is configured to slide between the closed position and the open position. For example, the door 158 is slidably retained between a front surface and a rear surface of the divider wall 154. As another example, the door 158 can be pivotally coupled to the divider wall 154, and configured to pivot between the closed position and the open position.

A closeout membrane 162 extends along an outer periphery of the divider wall 154. For example, the closeout membrane 162 extends along an outer edge of sides 164, upper angled portions 166, and a top 168 of the divider wall 154. The closeout membrane 162 is configured to abut against the outer walls 144, upper angled walls 145, and a ceiling 146 of the cargo compartment 140.

The closeout membrane 162 can be secured along the periphery of the divider wall 154 by adhesives, fasteners, and/or the like. In at least one example, the closeout membrane 162 is an inflatable membrane, which can be inflated with air. As another example, the closeout membrane 162 can be formed of rubber.

The closeout membrane 162 provides a flexible structure that sealingly engages the walls 144, 145, and the ceiling 146 of the cargo compartment. In at least one example, the closeout membrane 162 does not provide an air tight seal with the walls 144, 145, and the ceiling 146. As such, while the closeout membrane 162 sealingly abuts against portions of the cargo compartment 140, the closeout membrane 162 can allow for some airflow.

In at least one example, the barrier system 150 is configured to be used with and/or secured to a cargo handling system within the cargo compartment 140. As shown in FIG. 2, in particular, the barrier system 150 is configured to be moved to a desired position within the cargo compartment 140 to provide an isolation zone 170 for sensitive cargo. The door 158 can be opened to allow for passage into and out of the isolation zone 170. The vents 156 allow for a controlled amount of air exchange between the isolation zone 170 and an adjacent zone 172 of the cargo compartment 140. The barrier system 150 can be moved linearly moved in the directions of arrows A to provide for a smaller or larger isolation zone 170. The divider wall 154 provides thermal isolation between the isolation zone 170 and the adjacent zone 172. Multiple barrier systems 150 can be used to create multiple isolation zones.

As described herein the barrier system 150 is configured for a cargo compartment 140 of an aircraft. The barrier system 150 includes the base 152 configured to be supported on the floor 142 of the cargo compartment 140. The divider wall 154 extends upwardly from the base 152. The closeout membrane 162 extends around one or more portions of the divider wall 154. The closeout membrane 162 is configured to sealingly engage one or more portions (such as side walls and a ceiling) of the cargo compartment 140. The barrier system 150 is moveable within the cargo compartment 140 to provide the isolation zone 170 (of a desired location and size) within the cargo compartment 140.

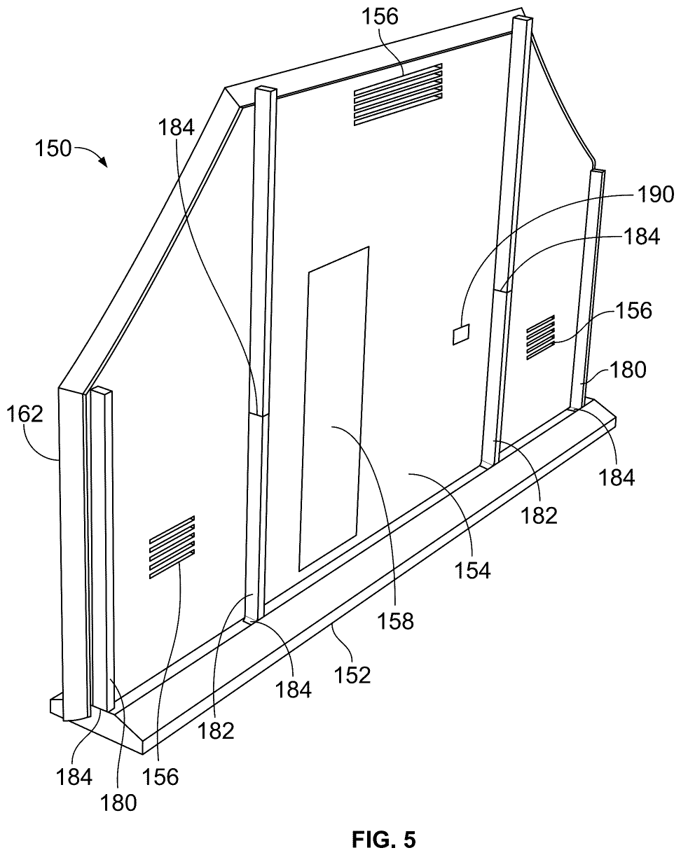

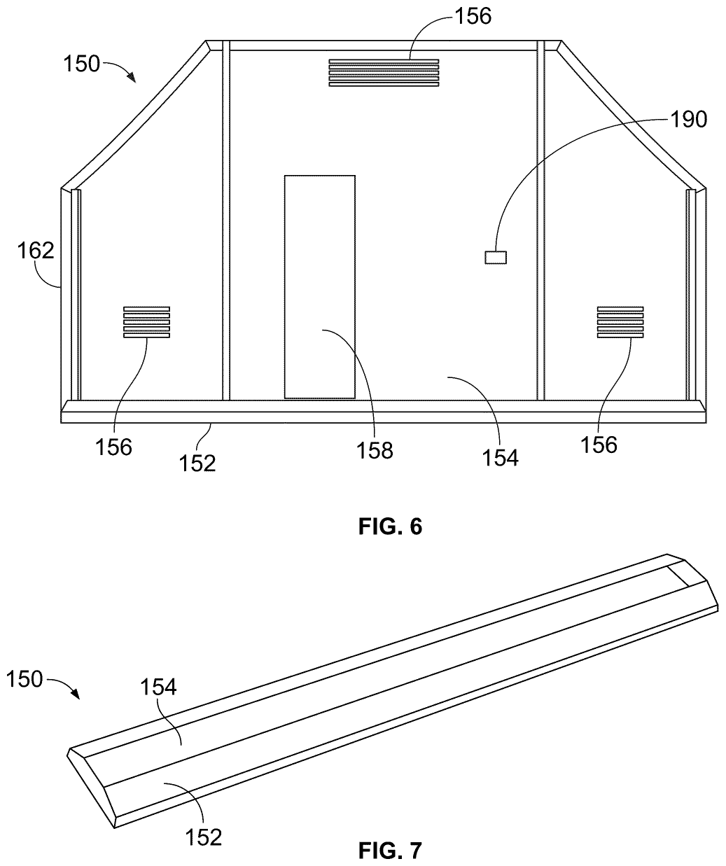

FIG. 5 illustrates an isometric front view of a barrier system 150 in a deployed position, according to an example of the present disclosure. FIG. 6 illustrates a front view of the barrier system 150 of FIG. 5. FIG. 7 illustrates an isometric top view of the barrier system 150 of FIG. 5 in a stowed position, according to an example of the present disclosure. Referring to FIGS. 5-7, in this example, the divider wall 154 is formed of a flexible material, such as rubber, foam, and/or the like. In at least one example, the divider wall 154 can be inflatable. The divider wall 154 is secured to support struts 180 and 182 extending upwardly from the base 152. For example, the divider wall 154 extends between the support struts 180. The support struts 180 and 182 include one or more pivots 184, which allow the support struts 180 and 182 to be moved between extended positions (as shown in FIG. 5) and collapsed positions. As the support struts 180 and 182 fold into the collapsed position, the divider wall 154 resiliently collapses in response thereto, in order to allow the divider wall 154 to collapse into a stowed position (shown in FIG. 7). As such, the support struts 180 and 182 are selectively moveable between the extended positions (shown in FIG. 5) and collapsed positions to move and support the divider wall 154 between a deployed position (shown in FIG. 5) and a stowed position (shown in FIG. 7).

The barrier system 150 can include more or less support struts than shown. For example, the barrier system 150 can include two support struts. As another example, the barrier system 150 can include six support struts. The barrier system 150 shown in FIGS. 5-7 provides a collapsible, and reconfigurable assembly adaptable to different interior configurations aboard different freighter aircraft.

Referring to FIGS. 1-7, the barrier systems 150 described herein can also include a user interface 190, which can include a thermostat, humidistat, and/or the like. For example, the user interface 190 can be mounted or otherwise disposed on the divider wall 154. The user interface 190 is in communication with an environmental control system (ECS) 192, such as through one or more wired or wireless connections. The user interface 190 allows for a desired temperature and/or humidity to be set within the isolation zone 170 (and/or the adjacent zone 172). The user interface 190 can be engaged by an individual to allow the ECS 192 to adapt conditions within the isolation zone 170 and/or the adjacent zone 172 to reduce a potential of excessive temperature difference and stratification therebetween. Optionally, the barrier systems 150 may not include the user interface.

The barrier systems 150 described herein are used onboard a freighter aircraft, and can be moved by a cargo handling system, to create selectable temperature zones that subdivide the cargo volumes into environmentally controlled areas. To reduce the impact to sensitive cargo, the barrier systems 150 are used to softly isolate specific regions of the cargo compartment 140, which allows for operations with one or more cargo doors open without drastically shifting the environment within the isolation zone 170. Air is still allowed to migrate into and out of the isolation zone 170 (such as through the vents 156), but at a reduced and controlled rate to prevent dramatic environmental shifts within the isolation zone 170.

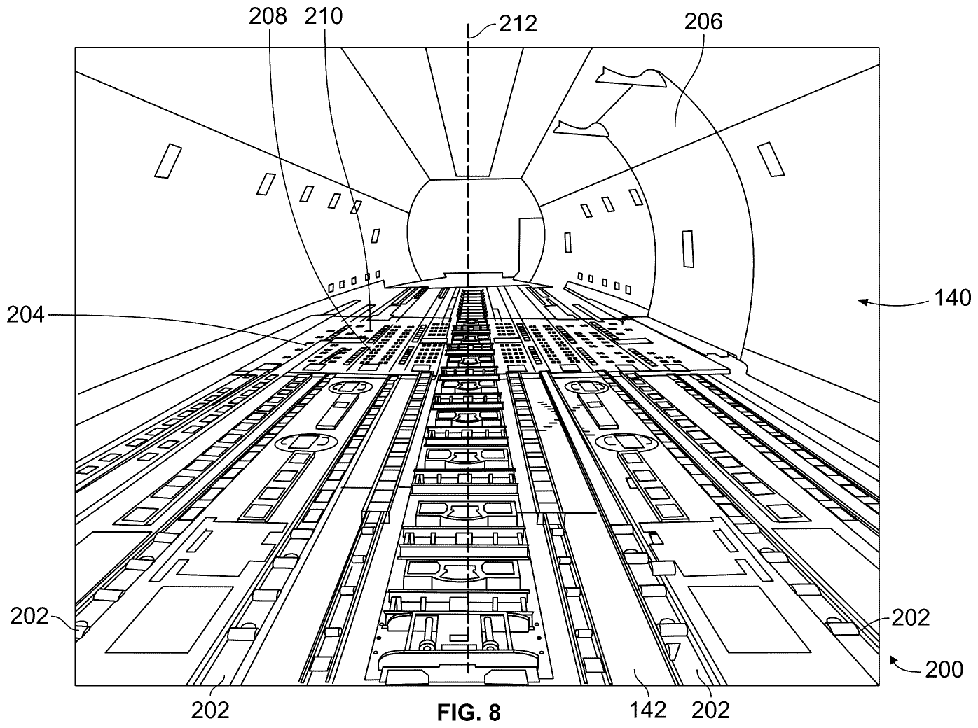

FIG. 8 illustrates an internal perspective view of a cargo compartment, according to an example of the present disclosure. The floor 142 supports a cargo handling system 200 that includes a plurality of roller tracks 202 that connect to an entry base 204, which is proximate to at least one door 206 that is configured to be opened and closed. The entry base 204 may include a plurality of passive ball transfer units 208. The entry base 204 may also include one or more power drive units 210. The passive ball transfer units 208 and the power drive units 210 are configured to move a cargo container (not shown in FIG. 8) onto the entry base 204 through the open door 206. Optionally, the entry base 204 may not include any power drive units 210.

As an example, a cargo container is typically loaded onto the entry base 204 in a direction that is perpendicular to a longitudinal plane 212 of the cargo compartment 140. After the cargo container is positioned over the entry base 204, the ball transfer units 208 and/or the power drive units 210 are operated to move the cargo container onto a parallel pair of roller tracks 202.

Referring to FIGS. 1-8, the base 152 of the barrier system 150 is supported on the floor 142, and is configured to be moved by the cargo handling system 200. The base 152 directly couples to the cargo handling system 200. For example, the base 152 can be rollingly supported by the roller tracks 202, and rolled thereon to a desired position within the cargo compartment 140.

Further, the disclosure comprises examples according to the following clauses:

Clause 1. A barrier system for a cargo compartment of an aircraft, the barrier system comprising:
a base configured to be supported on a floor of the cargo compartment;
a divider wall extending upwardly from the base; and
a closeout membrane extending around one or more portions of the divider wall, wherein the closeout membrane is configured to sealingly engage one or more portions of the cargo compartment,
wherein the barrier system is configured to be moved within the cargo compartment to provide an isolation zone within the cargo compartment.

Clause 2. The barrier system of Clause 1, wherein the cargo system is configured to linearly translate along a length of the cargo compartment.

Clause 3. The barrier system of Clauses 1 or 2, wherein the base comprises one or more rollers, wherein the one or more rollers are configured to allow the barrier system to roll over the floor of the cargo compartment.

Clause 4. The barrier system of any of Clauses 1-3, wherein the base is coupled to a cargo handling system that is configured to move the barrier system within the cargo compartment.

Clause 5. The barrier system of any of Clauses 1-4, wherein the divider wall is rigid.

Clause 6. The barrier system of any of Clauses 1-5, wherein the divider wall comprises one or more vents.

Clause 7. The barrier system of any of Clauses 1-6, further comprising a door moveably coupled to the divider wall, wherein the door is moveable between an open position and a closed position.

Clause 8. The barrier system of any of Clauses 1-7, wherein the closeout membrane is inflatable.

Clause 9. The barrier system of any of Clauses 1-4 or 6-8, further comprising one or more support struts, wherein the divider wall is flexible and coupled to the one or more support struts, wherein the one or more support struts are moveable between an extended position and a collapsed position, wherein the one or more support struts in the extended position support the divider wall in a deployed position, and wherein the one or more support struts in the collapsed position support the divider wall in a stowed position.

Clause 10. The barrier system of any of Clauses 1-9, further comprising a user interface in communication with an environmental control system.

Clause 11. A method for a barrier system within a cargo compartment of an aircraft, the barrier system comprising:
a base supported on a floor of the cargo compartment;
a divider wall extending upwardly from the base; and
a closeout membrane extending around one or more portions of the divider wall, wherein the closeout membrane sealingly engages one or more portions of the cargo compartment,
the method comprising:
moving the barrier system within the cargo compartment to provide an isolation zone within the cargo compartment.

Clause 12. An aircraft comprising:
a cargo compartment having a floor;
a barrier system comprising:
   a base configured supported on the floor of the cargo compartment;
   a divider wall extending upwardly from the base; and
   a closeout membrane extending around one or more portions of the divider wall, wherein the closeout membrane is configured to sealingly engage one or more portions of the cargo compartment,
   wherein the barrier system is moveable within the cargo compartment to provide an isolation zone within the cargo compartment.

Clause 13. The aircraft of Clause 12, wherein the cargo system is configured to linearly translate along a length of the cargo compartment.

Clause 14. The aircraft of Clauses 12 or 13, wherein the base comprises one or more rollers, wherein the one or more rollers are configured to allow the barrier system to roll over the floor of the cargo compartment.

Clause 15. The aircraft of any of Clauses 12-14, further comprising a cargo handling system on the floor, wherein the base is coupled to the cargo handling system.

Clause 16. The aircraft of any of Clauses 12-15, wherein the divider wall is rigid.

Clause 17. The aircraft of any of Clauses 12-16, wherein the divider wall comprises one or more vents, and wherein the barrier system further comprises a door moveably coupled to the divider wall, wherein the door is moveable between an open position and a closed position.

Clause 18. The aircraft of any of Clauses 12-17, wherein the closeout membrane is inflatable.

Clause 19. The aircraft of any of Clauses 12-15, 17, or 18, wherein the barrier system further comprises one or more support struts, wherein the divider wall is flexible and coupled to the one or more support struts, wherein the one or more support struts are moveable between an extended position and a collapsed position, wherein the one or more support struts in the extended position support the divider wall in a deployed position, and wherein the one or more support struts in the collapsed position support the divider wall in a stowed position.

Clause 20. The aircraft of any of Clauses 12-19, wherein the barrier system further comprises a user interface in communication with an environmental control system.

As described herein, examples of the present disclosure provide systems and methods for protecting certain types of cargo within a cargo compartment of a vehicle, such as a freighter aircraft. Further, examples of the present disclosure provide systems and methods for selectively segregating areas within a cargo compartment of a vehicle.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A barrier system for a cargo compartment of an aircraft, the barrier system comprising:
a base configured to be supported on a floor of the cargo compartment;
a divider wall extending upwardly from the base; and
a closeout membrane extending around one or more portions of the divider wall, wherein the closeout membrane is configured to sealingly engage one or more portions of the cargo compartment,
wherein the barrier system is configured to be moved within the cargo compartment to provide an isolation zone within the cargo compartment.

2. The barrier system of claim 1, wherein the cargo system is configured to linearly translate along a length of the cargo compartment.

3. The barrier system of claim 1, wherein the base comprises one or more rollers, wherein the one or more rollers are configured to allow the barrier system to roll over the floor of the cargo compartment.

4. The barrier system of claim 1, wherein the base is coupled to a cargo handling system that is configured to move the barrier system within the cargo compartment.

5. The barrier system of claim 1, wherein the divider wall is rigid.

6. The barrier system of claim 1, wherein the divider wall comprises one or more vents.

7. The barrier system of claim 1, further comprising a door moveably coupled to the divider wall, wherein the door is moveable between an open position and a closed position.

8. The barrier system of claim 1, wherein the closeout membrane is inflatable.

9. The barrier system of claim 1, further comprising one or more support struts, wherein the divider wall is flexible and coupled to the one or more support struts, wherein the one or more support struts are moveable between an extended position and a collapsed position, wherein the one or more support struts in the extended position support the divider wall in a deployed position, and wherein the one or more support struts in the collapsed position support the divider wall in a stowed position.

10. The barrier system of claim 1, further comprising a user interface in communication with an environmental control system.

11. A method for a barrier system within a cargo compartment of an aircraft, the barrier system comprising:
a base supported on a floor of the cargo compartment;
a divider wall extending upwardly from the base; and
a closeout membrane extending around one or more portions of the divider wall, wherein the closeout membrane sealingly engages one or more portions of the cargo compartment,
the method comprising:
moving the barrier system within the cargo compartment to provide an isolation zone within the cargo compartment.

12. An aircraft comprising:
a cargo compartment having a floor;
a barrier system comprising:
a base configured supported on the floor of the cargo compartment;
a divider wall extending upwardly from the base; and
a closeout membrane extending around one or more portions of the divider wall, wherein the closeout membrane is configured to sealingly engage one or more portions of the cargo compartment,
wherein the barrier system is moveable within the cargo compartment to provide an isolation zone within the cargo compartment.

13. The aircraft of claim 12, wherein the cargo system is configured to linearly translate along a length of the cargo compartment.

14. The aircraft of claim 12, wherein the base comprises one or more rollers, wherein the one or more rollers are configured to allow the barrier system to roll over the floor of the cargo compartment.

15. The aircraft of claim 12, further comprising a cargo handling system on the floor, wherein the base is coupled to the cargo handling system.

16. The aircraft of claim 12, wherein the divider wall is rigid.

17. The aircraft of claim 12, wherein the divider wall comprises one or more vents, and wherein the barrier system further comprises a door moveably coupled to the divider wall, wherein the door is moveable between an open position and a closed position.

18. The aircraft of claim 12, wherein the closeout membrane is inflatable.

19. The aircraft of claim 12, wherein the barrier system further comprises one or more support struts, wherein the divider wall is flexible and coupled to the one or more support struts, wherein the one or more support struts are moveable between an extended position and a collapsed position, wherein the one or more support struts in the extended position support the divider wall in a deployed position, and wherein the one or more support struts in the collapsed position support the divider wall in a stowed position.

20. The aircraft of claim 12, wherein the barrier system further comprises a user interface in communication with an environmental control system.
